(19) United States
(12) Patent Application Publication
(10) Pub. No.: US 2018/0142809 A1
(43) Pub. Date: May 24, 2018

(54) SYSTEMS AND METHODS FOR ENSURING THE CORRECT ORIENTATION OF TUBING IN A GAS TURBINE ENGINE

(71) Applicant: General Electric Company, Schenectady, NY (US)

(72) Inventors: Camilo Alberto García López, Querétaro (MX); Ricardo Vázquez Martínez, Querétaro (MX); Salvador Zavala Pérez, Querétaro (MX)

(73) Assignee: General Electric Company, Schenectady, NY (US)

(21) Appl. No.: 15/360,167

(22) Filed: Nov. 23, 2016

(51) Int. Cl. F16L 1/00; F02C 3/04

(52) U.S. Cl. CPC F16L 1/00; F05D 2220/32; F05D 2230/60; F02C 3/04

(57) ABSTRACT

A method for ensuring the correct orientation of tubing in a gas turbine engine. The method including prefabricating a first alignment bend in a first tube, prefabricating a second alignment bend in a second tube, aligning the first alignment bend in the same plane as the second alignment bend to place the first tube and the second tube in the correct orientation during installation, and connecting the first tube and the second tube.

### FIELD

The disclosure relates generally to gas turbine engines and more particularly relates to systems and methods for ensuring the correct orientation of tubing in a gas turbine engine.

### BACKGROUND

Gas turbine engines may include a number of tube segments to connect various components within the gas turbine engine. To ensure the proper function of the gas turbine engine, the tube segments should be properly aligned and positioned in the correct orientation. Due to the lack of any indicators, however, the tube segments may not be installed correctly. For example, the tube segments may be attached to one another in the wrong orientation such that an end of the tube may be in the wrong location or facing the wrong direction. This can lead to substantial delays and costs.

### BRIEF DESCRIPTION

According to an embodiment, there is disclosed a method for ensuring the correct orientation of tubing in a gas turbine engine. The method may include prefabricating a first alignment bend in a first tube, prefabricating a second alignment bend in a second tube, aligning the first alignment bend in the same plane as the second alignment bend to place the first tube and the second tube in the correct orientation during installation, and connecting the first tube and the second tube.

According to another embodiment, there is disclosed a system for ensuring the correct orientation of tubing in a gas turbine engine. The system may include a first tube having a first alignment bend and a second tube having a second alignment bend. The first alignment bend may lie in the same plane as the second alignment bend when the first tube and the second tube are in the proper orientation during installation.

Further, according to another embodiment, there is disclosed a gas turbine engine. The gas turbine engine may include a first tube having a first prefabricated alignment bend and a second tube having a second prefabricated alignment bend. The first prefabricated alignment bend may lie in the same plane as the second prefabricated alignment bend when the first tube and the second tube are in the proper orientation during installation.

Other embodiments, aspects, and features of the disclosure will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale.

FIG. 1 depicts of an example gas turbine engine according to an embodiment.

FIG. 2 depicts a number of tube segments attached together according to an embodiment.

FIG. 3 depicts a number of tube segments attached together according to an embodiment.

FIGS. 4A and 4B depict two tube segments attached together according to an embodiment.

FIGS. 5A and 5B depict two tube segments attached together according to an embodiment.

FIGS. 6A and 6B depict two tube segments attached together and aligned in the correct orientation according to an embodiment.

FIGS. 7A and 7B depict two tube segments attached together and aligned in the incorrect orientation according to an embodiment.

### DETAILED DESCRIPTION

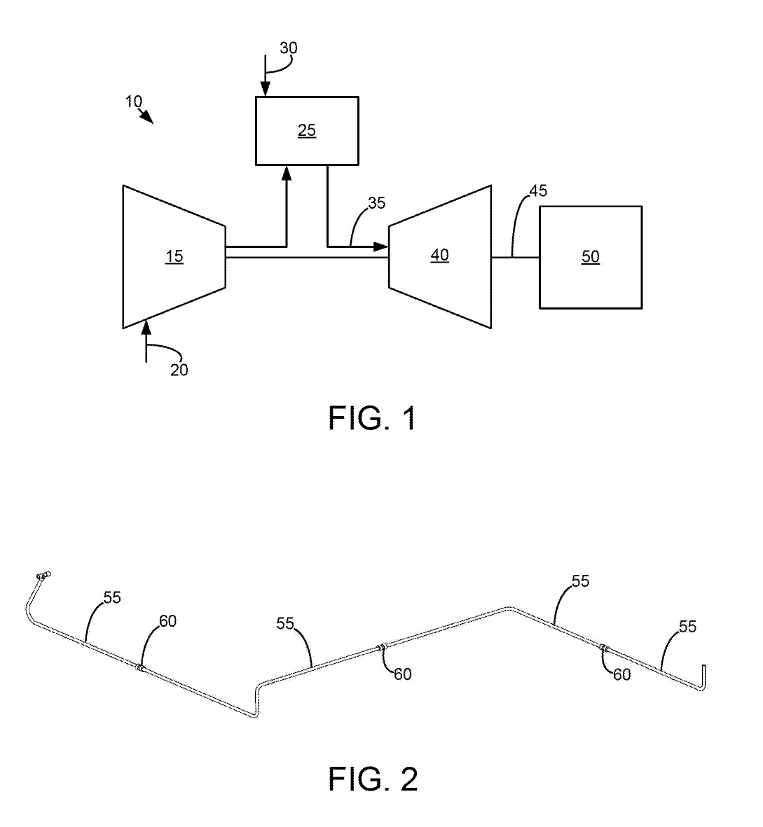

Referring now to the drawings, in which like numerals refer to like elements throughout the several views, FIG. 1 depicts a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

FIG. 2 depicts a number of tube segments 55 that may be used to connect various components of the gas turbine engine 10. The tube segments 55 may be connected to one another by connectors 60. To ensure proper function of the gas turbine engine 10, the tube segments 55 should be properly aligned and positioned in the correct orientation. Due to the lack of any indicators, however, the tube segments 55 may not be installed correctly. For example, the tube segments 55 may be attached to one another in the wrong orientation such that an end of the tube may be in the wrong location or facing the wrong direction. This can lead to substantial delays and costs.

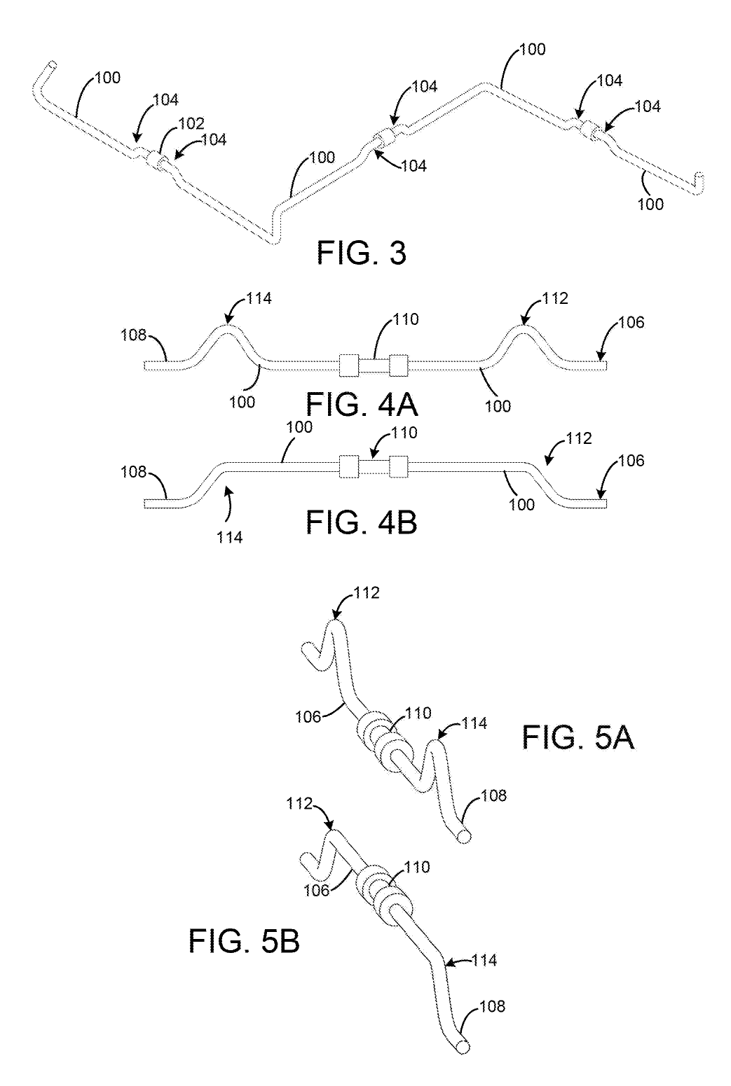

FIGS. 3-6B depict systems and methods for ensuring the correct orientation of tubing in a gas turbine engine. For example, FIG. 3 depicts a number of tube segments 100 that may be used to connect various components of the gas turbine engine 10. In some instances, the tube segments 100 may be connected to one another by connectors 102. To ensure that the tube segments 100 are properly aligned and positioned in the correct orientation, each of the tube segments 100 may include an alignment bend 104. The alignment bend 104 may be prefabricated into the tube segments 100 prior to installation of the tube segments 100. In some instances, each of the tube segments 100 may include multiple alignment bends 104. For example, each end of the tube segments 100 may include an alignment bend 104. Any number of alignment bends 104 may be used herein. As discussed in greater detail below, the alignments bends 104 at the ends of adjacent tube segments 100 may be positioned parallel to each other and in the same plane to ensure the proper orientation of the tube segments 100 during installation. Once in the correct positon, the tube segments 100 may be attached to one another.

For simplicity, FIGS. 4A-5B depict two tube segments 100 with alignments bends 104. Any number of tube segments 100 with alignment bends 104 may be attached to one another. As depicted in FIGS. 4A-5B, a first tube 106 may be attached to a second tube 108. In some instances, a connector 110 may be used to attach the first tube 106 to the second tube 108. Any means may be used to attach the first tube 106 to the second tube 108. The first tube 106 and the second tube 108 may connect two or more components in the gas turbine engine 10.

The first tube 106 may include a first alignment bend 112, and the second tube 108 may include a second alignment bend 114. In some instances, the first alignment bend 112 may be prefabricated into the first tube 106 prior to installation, and the second alignment bend 114 may be prefabricated into the second tube 108 prior to installation. In some instances, the first alignment bend 112 and/or the second alignment bend 114 may be V-shaped, U-shaped, or Z-shaped. The first alignment bend 112 and the second alignment bend 114 may be any size, shape, or configuration. For example, as depicted in FIGS. 4A and 5A, the first alignment bend 112 and the second alignment bend 114 may form an inverted U-shape. As depicted in FIGS. 4B and 5B, the first alignment bend 112 and the second alignment bend 114 may form a stretched out Z-like shape. In some instances, the first alignment bend 112 may be the same shape as the second alignment bend 114. In other instances, the first alignment bend 112 may be a different shape than the second alignment bend 114.

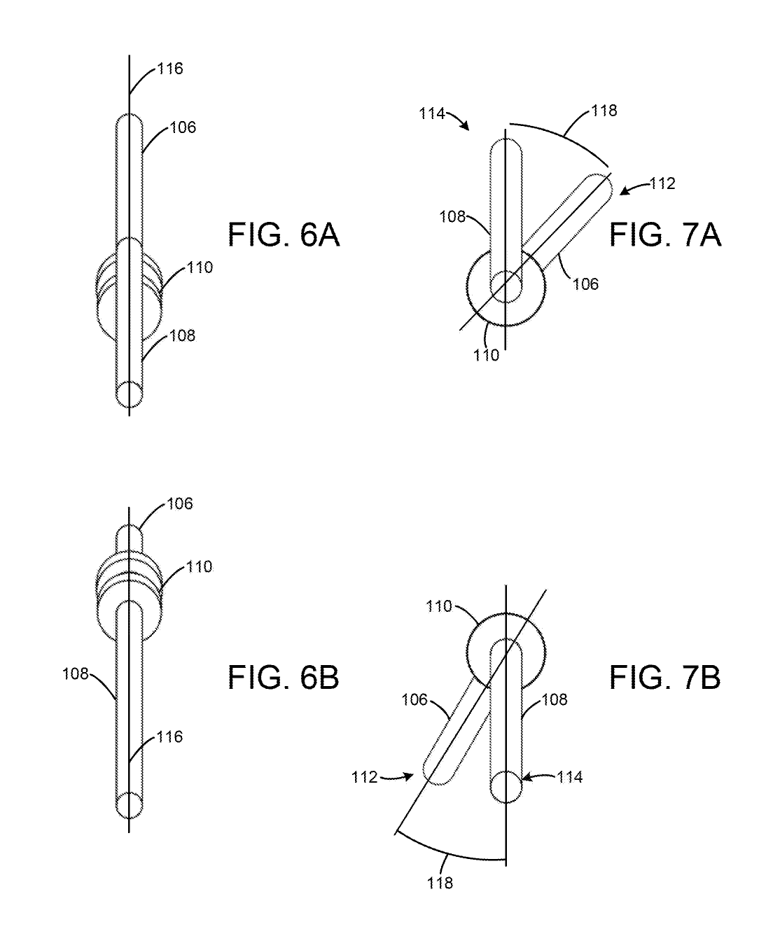

As depicted in FIGS. 6A and 6B, in order to properly align the first tube 106 with the second tube 108 and to ensure that the first tube 106 and the second tube 108 are in the correct orientation, the first alignment bend 112 may be positioned parallel to and lie in the same plane 116 as the second alignment bend 114 when the first tube 106 and the second tube 108 are in the proper orientation during installation. Conversely, as depicted in FIGS. 7A and 7B, if the first alignment bend 114 is angled 118 relative to the second alignment bend 114 and lies in a different plane than the second alignment bend 114, then the first tube 106 and the second tube 108 are in the incorrect orientation during installation. In such instances, the installer may visually see the misalignment and adjust the first tube 106 and the second tube 108 into the correct orientation such that the first alignment bend 112 is positioned parallel to and lies in the same plane 116 as the second alignment bend 114.

Accordingly, the first alignment bend 112 may be prefabricated into the first tube 106 prior to installation. Likewise, the second alignment bend 114 may be prefabricated into the second tube 108 prior to installation. The first alignment bend 112 may then be aligned in the same plane as the second alignment bend 114 to place the first tube 106 and the second tube 108 in the correct orientation during installation. Once in the correct orientation, the first tube 106 and the second tube 108 may be connected.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof. Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A method for ensuring the correct orientation of tubing in a gas turbine engine, the method comprising:
prefabricating a first alignment bend in a first tube;
prefabricating a second alignment bend in a second tube;
aligning the first alignment bend in the same plane as the second alignment bend to place the first tube and the second tube in the correct orientation during installation; and
connecting the first tube and the second tube.

2. The method of claim 1, further comprising prefabricating the first alignment bend and the second alignment bend as the same shape.

3. The system of claim 1, further comprising determining that the first tube and the second tube are in the incorrect orientation during installation when the first alignment bend is angled relative to the second alignment bend and lies in a different plane than the second alignment bend.

4. The system of claim 1, further comprising connecting two or more components in the gas turbine engine with the first tube and the second tube.

5. A system for ensuring the correct orientation of tubing in a gas turbine engine, the system comprising:
a first tube having a first alignment bend; and
a second tube having a second alignment bend,
wherein the first alignment bend lies in the same plane as the second alignment bend when the first tube and the second tube are in the proper orientation during installation.

6. The system of claim 5, wherein the first alignment bend is prefabricated into the first tube prior to installation.

7. The system of claim 5, wherein the second alignment bend is prefabricated into the second tube prior to installation.

8. The system of claim 5, wherein the first alignment bend is V-shaped, U-shaped, or Z-shaped.

9. The system of claim 5, wherein the second alignment bend is V-shaped, U-shaped, or Z-shaped.

10. The system of claim 5, wherein the first alignment bend is the same shape as the second alignment bend.

11. The system of claim 5, further comprising a connector connecting the first tube and the second tube.

12. The system of claim 5, wherein the first alignment bend is angled relative to the second alignment bend and lies in a different plane than the second alignment bend when the first tube and the second tube are in the incorrect orientation during installation.

13. The system of claim 5, wherein the first tube and the second tube connect two or more components in the gas turbine engine.

14. A gas turbine engine, comprising:
a first tube having a first prefabricated alignment bend; and
a second tube having a second prefabricated alignment bend,
wherein the first prefabricated alignment bend lies in the same plane as the second prefabricated alignment bend when the first tube and the second tube are in the proper orientation during installation.

15. The gas turbine engine of claim 14, wherein the first prefabricated alignment bend is V-shaped, U-shaped, or Z-shaped.

16. The gas turbine engine of claim 14, wherein the second prefabricated alignment bend is V-shaped, U-shaped, or Z-shaped.

17. The gas turbine engine of claim 14, wherein the first prefabricated alignment bend is the same shape as the second prefabricated alignment bend.

18. The gas turbine engine of claim 14, further comprising a connector connecting the first tube and the second tube.

19. The gas turbine engine of claim 14, wherein the first prefabricated alignment bend is angled relative to the second prefabricated alignment bend and lies in a different plane than the second prefabricated alignment bend when the first tube and the second tube are in the incorrect orientation during installation.

20. The gas turbine engine of claim 14, wherein the first tube and the second tube connect two or more components in the gas turbine engine.
